(19) United States
(12) Patent Application Publication
(10) Pub. No.: US 2011/0090830 A1
(43) Pub. Date: Apr. 21, 2011

(54) INFORMATION PROCESSING APPARATUS INCLUDING PLURALITY OF COMMUNICATION INTERFACES AND CONTROL METHOD FOR INFORMATION PROCESSING APPARATUS

(75) Inventor: Koji Churei, Kawasaki-shi (JP)

(73) Assignee: CANON KABUSHIKI KAISHA, Tokyo (JP)

(21) Appl. No.: 12/903,951

(22) Filed: Oct. 13, 2010

(30) Foreign Application Priority Data
Oct. 19, 2009 (JP) PCT/JP2009/068031

(51) Int. Cl. G08C 17/00

(52) U.S. Cl. 370/311

(57) ABSTRACT

To enable an apparatus including a plurality of communication interfaces to return from a power-saving state when receiving an activation packet via any of the communication interfaces.

Identifying information for each communication interface is stored, and for an activation packet received via any of the communication interfaces, if identifying information contained in the activation packet matches the stored identifying information, the apparatus is returned from the power-saving state.

### TECHNICAL FIELD

The present invention relates to an information processing apparatus including a plurality of communication interfaces and a control method for the information processing apparatus.

### BACKGROUND ART

Nowadays, many information processing apparatuses incorporate the power management feature aimed at reducing power consumption. The power management feature is a feature of stopping part of the functions when an information processing apparatus is not in use and shifting the information processing apparatus to a power-saving state (sleep mode).

Traditionally, as a method of returning from a power-saving state to a normal state, a technique that employs detection of access to a communication interface included in an information processing apparatus exists. For example, for a network interface, such as Ethernet (trademark), the Wake-On-LAN (WOL) feature is known. WOL is a feature of, when a specific packet is received through a network interface, causing an information processing apparatus to return from a power-saving state. One known example of that specific packet used in WOL is Magic Packet (trademark) developed by Advanced Micro Devices (AMD).

A magic packet is an Ethernet packet that contains a special data pattern and that is transmitted in a broadcast fashion, and typically, employs user datagram protocol (UDP). For a magic packet, a pattern in which the media access control (MAC) address of an information processing apparatus that is a target to be returned from a power-saving state is repeated multiple times is described in a payload section of a UDP packet. When identifying that the MAC address of its own is described in the payload section of the UDP packet of the received magic packet, a communication interface of the information processing apparatus outputs a signal for causing the entire device to return.

Patent Literature 1 describes a method of remotely activating a computer including a serial bus interface from an external device.

Patent Literature 2 describes a method of remotely activating a system using Wake-on-Wireless LAN (WoWLAN), which is extension from WOL to wireless networking.

For embedded devices or other devices, multi-central processing unit (CPU) systems, each of which incorporates a plurality of CPUs, have increased recently. Such systems also require lower power consumption. Patent Literature 3 describes a method of carrying out WOL in an information processing apparatus that includes a main CPU controlling the entire system and a sub-CPU exercising preset control within the system.

### Citation List

Patent Literature

PTL 1 Japanese Patent Laid-Open No. 2000-209220

PTL 2 Japanese Patent Laid-Open No. 2005-018377

PTL 3 Japanese Patent Laid-Open No. 2005-267100

As described above, to transmit a magic packet, it is necessary to contain the MAC address of a communication interface included in a target information processing apparatus in a payload section of a UDP packet. Therefore, in order to employ the WOL and WoWLAN features in an information processing apparatus including a plurality of communication interfaces, it is necessary to change the content of the magic packet depending on which communication interface is to be used in transmitting the magic packet therethrough. For an information processing apparatus including a plurality of communication interfaces, causing all of the communication interfaces to concurrently operate may be prohibited. To transmit a magic packet to such an information processing apparatus, it is necessary for an apparatus that aims to transmit it to generate the magic packet in consideration of which communication interface is in use by a destination information processing apparatus.

It is an object of the present invention to provide a control method suited for shifting an information processing apparatus including a plurality of communication interfaces from a power-saving state to another operation state.

### SUMMARY OF INVENTION

According to an aspect of the present invention, an apparatus includes a plurality of communication interfaces, a main section configured to perform control over a predetermined application, a communication section configured to perform control over communication via the plurality of communication interfaces, and a power control section configured to perform control over power supply to the main section. The communication section is configured to, when receiving an activation packet for causing the main section to shift from a power-saving state to another operation state via any one of the plurality of communication interfaces, if the activation packet contains identifying information for another communication interface, provide the power control section with an instruction to shift the main section from a power-saving state to another operation state.

According to another aspect of the present invention, an apparatus includes a plurality of communication interfaces, a receiving unit configured to receive an activation packet for causing the apparatus to shift from a power-saving state to another operation state via any one of the plurality of communication interfaces, a determining unit configured to determine whether the received activation packet contains identifying information for another communication interface, and a control unit configured to control the apparatus to shift from the power-saving state to the other operation state based on a determination made by the determining unit.

According to another aspect of the present invention, a method for an apparatus including a plurality of communication interfaces includes receiving an activation packet for causing the apparatus to shift from a power-saving state to another operation state, determining whether the received activation packet contains identifying information for another communication interface, and controlling the apparatus to shift from the power-saving state to the other operation state based a determination made in the determining.

Further features of the present invention will become apparent from the following description of exemplary embodiments with reference to the attached drawings.

### BRIEF DESCRIPTION OF DRAWINGS

FIG. 1 illustrates an information processing apparatus in which the present invention can be carried out.

FIG. 2 is a block diagram of an information processing apparatus in which the present invention can be carried out.

FIG. 3 is a sequence diagram of a main communication processing section.

FIG. 4 is a flowchart that illustrates operation of a communication processing section.

FIG. 5 is a flowchart that illustrates a modification example of operation of the communication processing section.

### DESCRIPTION OF EMBODIMENTS

### First Embodiment

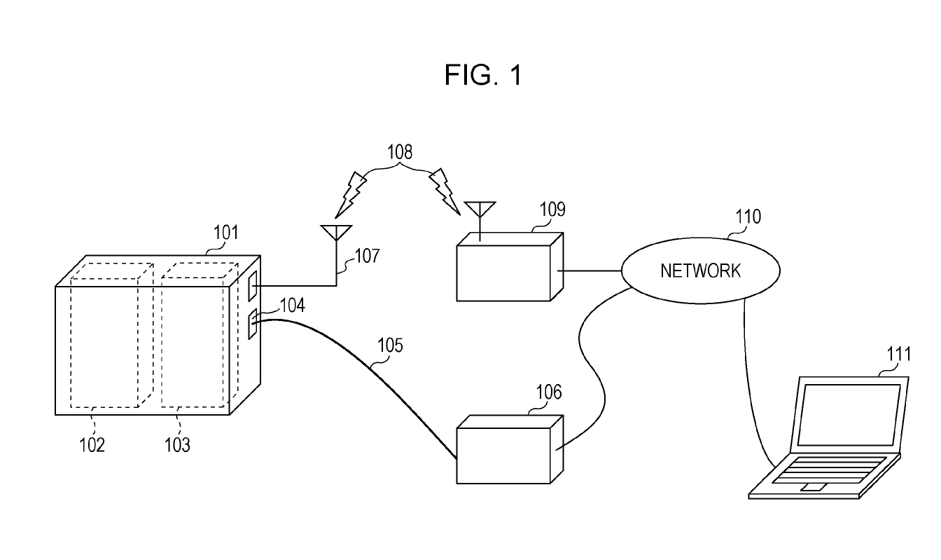

FIG. 1 illustrates a communication system to which an interface control technique according to the present invention is applicable.

An information processing apparatus 101 includes a main processing section (main system) 102 and a communication processing section (sub-system) 103. The main processing section 102 is a system for controlling an application of the information processing apparatus 101. For example, the main processing section 102 performs control over printing when the information processing apparatus 101 is a printer, control over imaging when it is a camera, and control over displaying when it is a display. The main processing section 102 does not perform processing relating to communication. The processing relating to communication is performed by the communication processing section 103.

The information processing apparatus 101 includes a plurality of communication interfaces. The communication processing section 103 controls communication conducted through each of the communication interfaces. For the example illustrated in FIG. 1, the communication processing section 103 supports two communication modes; one is wireless communication and the other is wired communication. Here, the information processing apparatus 101 cannot cause both a wired interface and a wireless interface to concurrently operate.

An interface for use in wired communication (hereinafter, wired interface) can be a cable socket 104, for example. A communication interface for use in wireless communication (hereinafter, wireless interface) can be an antenna 107, for example.

Each of the communication interfaces establishes a network with another device through each communication medium. For wired communication, the information processing apparatus 101 is connected to a network 110 through the cable socket 104 and a connection cable 105 and through a wired communication device 106. Examples of the wired communication device 106 can include a hub and a switch. For wireless communication, the information processing apparatus 101 is connected to the network 110 through, from the antenna 107, air 108 and through a wireless communication device 109. Examples of the wireless communication device 109 can include an access point (base station).

An external apparatus 111 is connected to the wired communication device 106 and the wireless communication device 109 over the network 110 and can conduct data communication with the information processing apparatus 101. For example, when the information processing apparatus 101 is a printer, an instruction to perform printing provided by the external apparatus 111 over the network can cause the information processing apparatus 101 to perform printing.

The information processing apparatus 101 can support Wake-On-LAN (WOL) and Wake-on-Wireless LAN (WoWLAN) and operates in either a normal operation state or a power-saving state. When the information processing apparatus 101 is in a normal operation state, normal power supply is provided to circuits of the main processing section 102 and the communication processing section 103.

In contrast, when the information processing apparatus 101 is in a power-saving state, the main processing section 102 is in an application stop state. In a power-saving state, power supply to at least part of the main processing section 102 is stopped, an operating voltage is reduced, or the like. At that time, the communication processing section 103 is in a state where it can conduct either one of the wired communication and wireless communication, as in the state prior to a power-saving state.

When the information processing apparatus 101 is in a power-saving state, if the communication processing section 103 receives a magic packet or a packet having an equivalent function thereto (hereinafter referred to collectively as activation packet) from the external apparatus 111 through a communication interface, the main processing section 102 shifts from a power-saving state, where an application is stopped, to a normal operation state. In the case of a magic packet, a broadcast address is stored as a destination in a header section of a UDP packet, and a pattern in which the MAC address of a communication interface included in an information processing apparatus that is to be returned from a power-saving state is repeated multiple times is stored in a payload section (data section). In this way, an activation packet according to the present embodiment is a packet transmitted in a broadcast fashion, and the identifying information for a communication interface included in a target information processing apparatus that is to be returned from a power-saving state to a normal state is stored in a payload section (data section).

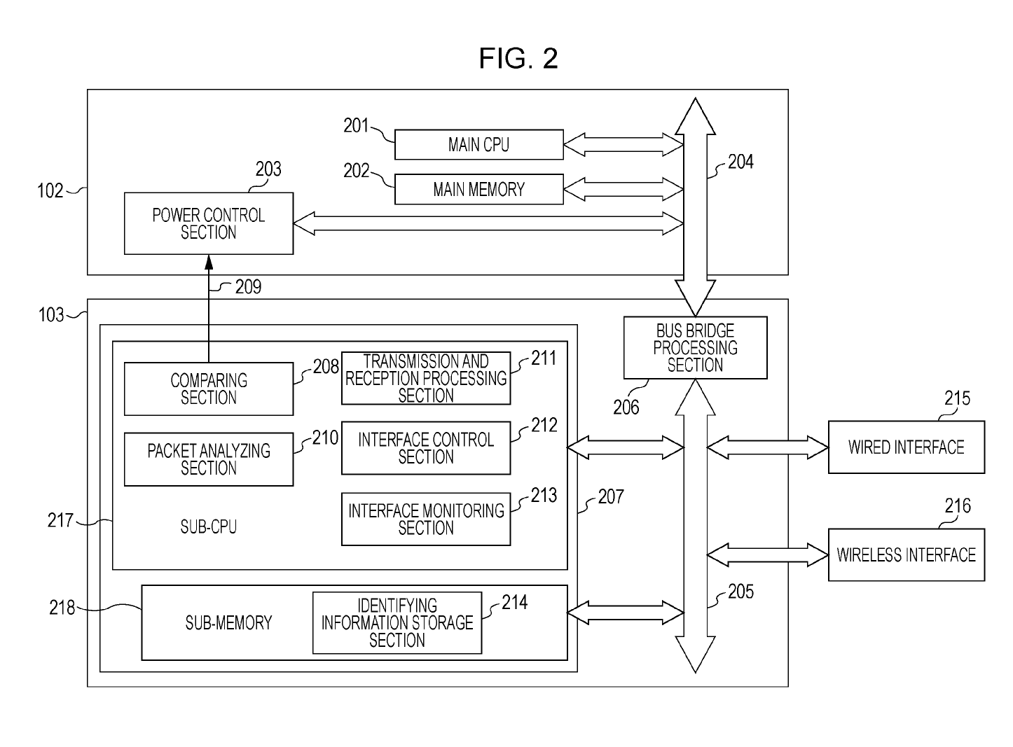

FIG. 2 is a block diagram that illustrates one example configuration of the information processing apparatus 101.

The main processing section 102 contains a main CPU 201, a main memory 202, and a power control section 203. The main CPU 201 is responsible for application control of the entire information processing apparatus.

The main memory 202 stores a program executed by the main CPU 201 and acts as a buffer memory for data handled by the main CPU 201.

The power control section 203 performs various kinds of control over shifting to a power-saving state and over returning from a power-saving state to a normal operation state of the main processing section 102.

Reference numeral 204 indicates a main bus that the main CPU 201 uses in accessing the functional blocks or integrated circuits (ICs).

Reference numeral 205 indicates is a local bus that a communication control section 207 uses in accessing the functional blocks or integrated circuits (ICs).

The communication processing section 103 contains a bus bridge processing section 206 and the communication control section 207.

The bus bridge processing section 206 performs processing relating to connection with the main bus 204 and the local bus 205.

The communication control section 207 includes a sub-CPU 217 and a sub-memory 218 and is responsible for control of the communication processing section 103. The sub-CPU 217 contains a comparing section 208, a packet analyzing section 210, a transmission and reception processing section 211, an interface control section 212, and an interface monitoring section 213. The sub-memory 218 contains an identifying information storage section 214.

The comparing section 208 compares identifying information from the packet analyzing section 210 and identifying information for a communication interface retained in the identifying information storage section 214. Then when there is a match of the identifying information, the comparing section 208 outputs a wake-up signal to the power control section 203. Reference numeral 209 indicates a signal line for use in transmitting a wake-up signal from the comparing section 208 to the power control section 203.

The packet analyzing section 210 analyzes an activation packet received by the transmission and reception processing section 211 and notifies the comparing section 208 of identifying information described in the activation packet. The transmission and reception processing section 211 is responsible for packet transmission processing or reception processing.

The identifying information storage section 214 stores identifying information for each of the communication interfaces included in the information processing apparatus 101. For the present embodiment, the identifying information storage section 214 stores identifying information for a wired interface 215 and identifying information for a wireless interface 216. The stored identifying information is used in comparing with identifying information described in an activation packet.

When the main processing section 102 is in a power-saving state, the interface control section 212 assigns at least one communication interface that can receive an activation packet. For the present embodiment, either one of the two communication interfaces (215, 216) is made to be in a state waiting for an activation packet.

The interface control section 212 writes identifying information for a communication interface into the identifying information storage section 214. The interface control section 212 receives notification indicating a communication status of each communication interface from the interface monitoring section 213. If the communication interface assigned as waiting for an activation packet is in a state where communication is disabled, the interface control section 212 switches another communication interface to a waiting state.

For the present embodiment, when the main processing section 102 is in a power-saving state, for example, the interface control section 212 assigns the wired interface 215 as an interface being in a state waiting for an activation packet. In this situation, if wired communication is disabled by, for example, a break of a cable, the interface control section 212 switches the wireless interface 216 to a waiting state. Additionally, the interface control section 212 writes the identifying information for the wireless interface 216 into the identifying information storage section 214.

The interface monitoring section 213 monitors communication environment of each communication interface to the outside and notifies the interface control section 212 of a communication status of each communication interface.

Reference numeral 215 indicates an interface for use in wired communication. For example, IEEE 802.3 wired LAN is applicable as the wired communication.

Reference numeral 216 indicates an interface for use in wireless communication. For example, IEEE 802.11 wireless LAN is applicable as the wireless communication. All the functional blocks are correlated in a software or hardware manner. The above functional blocks are examples; a plurality of functional blocks may form a single functional block, and one of the functional blocks may be divided into blocks performing a plurality of functions. For example, the interface monitoring section 213 may be incorporated in each of the communication interfaces 215 and 216. In this case, if a communication interface becomes a state where communication is disabled, the interface monitoring section 213 outputs an interrupt signal to the interface control section 212. In response to the interrupt signal, the interface control section 212 performs control of entering operation for switching a communication interface, thus enabling the present invention to be carried out.

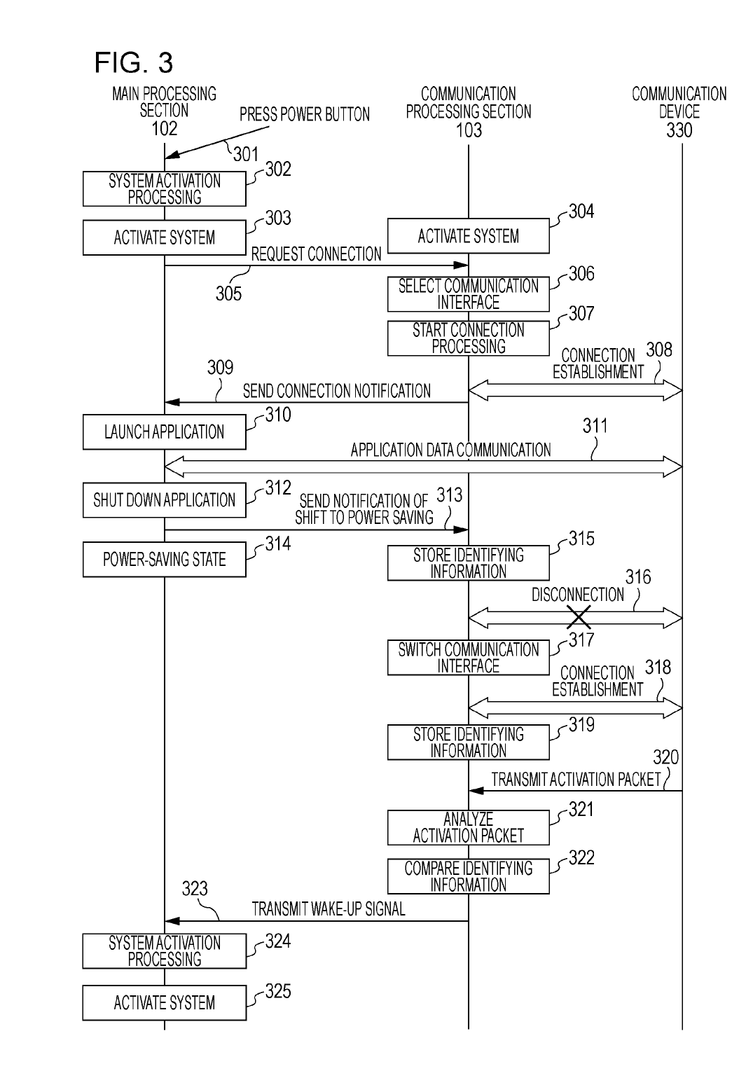

The present embodiment is described below using FIG. 3. FIG. 3 is a sequence diagram that illustrates operation of the main processing section 102, the communication processing section 103, and a communication device 330 according to the present embodiment. The communication device 330 is the wired communication device 106 or the wireless communication device 109 illustrated in FIG. 1.

In an initial state, the main processing section 102 is in a power OFF state or a power-saving state. In this state, for example, upon actuation of a button from a user (301), the main processing section 102 enters activation processing (302). Then the system of each of the main processing section 102 and the communication processing section 103 is activated and brought into a normal operation state (303, 304).

In that state, to establish connection with the communication device 330, the main processing section 102 transmits a connection request to the communication processing section 103 (305). In response to the connection request, the communication processing section 103 selects a communication interface to be used (306) and starts processing for connection with the communication device 330 (307). For example, when the wireless interface 107 is used in communication, the communication processing section 103 performs processing for wireless connection with the communication device 330 (in this case, the wireless communication device 109).

When a series of connection processing activities is completed and connection between the communication processing section 103 and the communication device 330 is established (308), the communication processing section 103 notifies the main processing section 102 of the establishment of connection (309). When the processing for connection with the communication device 330 is completed, communication with the external apparatus 111 illustrated in FIG. 1 over the network 110 is enabled.

When identifying the establishment of connection with the communication device 330, the main processing section 102 launches an application (310). Data for use in the application is exchanged between the main processing section 102 and the communication device 330 (311). Although not illustrated here, data used in the application is exchanged between the external apparatus 111 and the main processing section 102 illustrated in FIG. 1. For example, when the information processing apparatus 101 is a printer and is to perform printing processing on an image using a printing application in response to an instruction from the external apparatus 111, image data, notification indicating the state of progress of printing, and error notification (e.g., no paper, no ink remaining) can be exchanged. When application data communication (311) is completed, the main processing section 102 shuts down the application (312).

The main processing section 102 that does not need to execute the application notifies the communication processing section 103 of a state shift to a power-saving state (313) and shifts to a power-saving state (314). For example, when no user action has occurred for a predetermined period after the shutting down of the application, the main processing section 102 shifts to a power-saving state.

The communication processing section 103 having received notification of shifting to a power-saving state stores identifying information for a communication interface that can receive an activation packet in the identifying information storage section 214 (315). Here, the identifying information for the communication interface selected at 306 is stored in the identifying information storage section 214.

Here, if connection with the communication device 330 is broken for some reason (316), the communication processing section 103 switches a communication interface that waits for reception of an activation packet (317). Then connection with the communication device 330 is established through the switched communication interface (318). For example, when at 308 wireless connection with the communication device 330 (wireless communication device 109) through the wireless interface 216 has been established, if the wireless connection is broken by a change in a radio environment, the active interface is switched to the wired interface 215 at 317. At 318, connection with the communication device 330 (here, the wired communication device 106) is established through the wired interface 215. Alternatively, when at 308 wired connection with the communication device 330 (wired communication device 106) through the wired interface 215 has been established, if the connection cable is disconnected, the active interface is switched to the wireless interface 216 at 317. At 318, connection with the communication device 330 (here, the wireless communication device 109) is established through the wireless interface 216.

When the connection with the communication device 330 is established, the communication processing section 103 stores the identifying information for the communication interface being in a state waiting for an activation packet in the identifying information storage section 214 (319).

Here, if an activation packet is transmitted from the communication device 330 to the communication processing section 103 through the communication interface being in a state waiting for an activation packet (320), the communication processing section 103 analyzes the received activation packet (321) and compares the identifying information for the communication interface contained in the activation packet and identifying information retained in the identifying information storage section 214 (322). As a result of the comparison, when there is a match of the identifying information, the communication processing section 103 outputs a wake-up signal to the main processing section 102 being in a power-saving state (323). For example, when an activation packet is received through the wired interface 215, even if the identifying information contained in the activation packet is the identifying information for the wireless interface 216, a wake-up signal is transmitted.

The main processing section 102 having received the wake-up signal starts processing for shifting from a power-saving state to a normal operation state (324) and returns to the normal operation state (325).

For example, for the system illustrated in FIG. 1, when the information processing apparatus 101 has not been operated for a predetermined period after application data communication between the information processing apparatus 101 and the external apparatus 111 through the wireless communication device 109, the main processing section 102 shifts to a power-saving state. After that, if the communication through the wireless interface 107 (216) is disabled by a change in a radio environment, the information processing apparatus 101 switches the active interface to the wired interface 104 (215) and establishes connection with the wired communication device 106.

Here, it is assumed that the external apparatus 111 transmits the identifying information for the wireless interface 107 by containing it in an activation packet in order to conduct data communication with the information processing apparatus 101 again. At this time, because wireless connection between the wireless interface 107 and the wireless communication device 109 is broken, the activation packet does not reach the wireless interface 107. However, the activation packet is a broadcast packet, so the activation packet reaches the wired interface 104 through the wired communication device 106. The communication processing section 103 checks the identifying information contained in the activation packet received through the wired interface 104 and, if it matches the identifying information for the wireless interface 107, the communication processing section 103 transmits a wake-up signal to cancel the power-saving state of the main processing section 102.

In this way, the information processing apparatus according to the present embodiment operates so as to return from a power-saving state also when the identifying information contained in an activation packet received through one communication interface matches the identifying information for another communication interface.

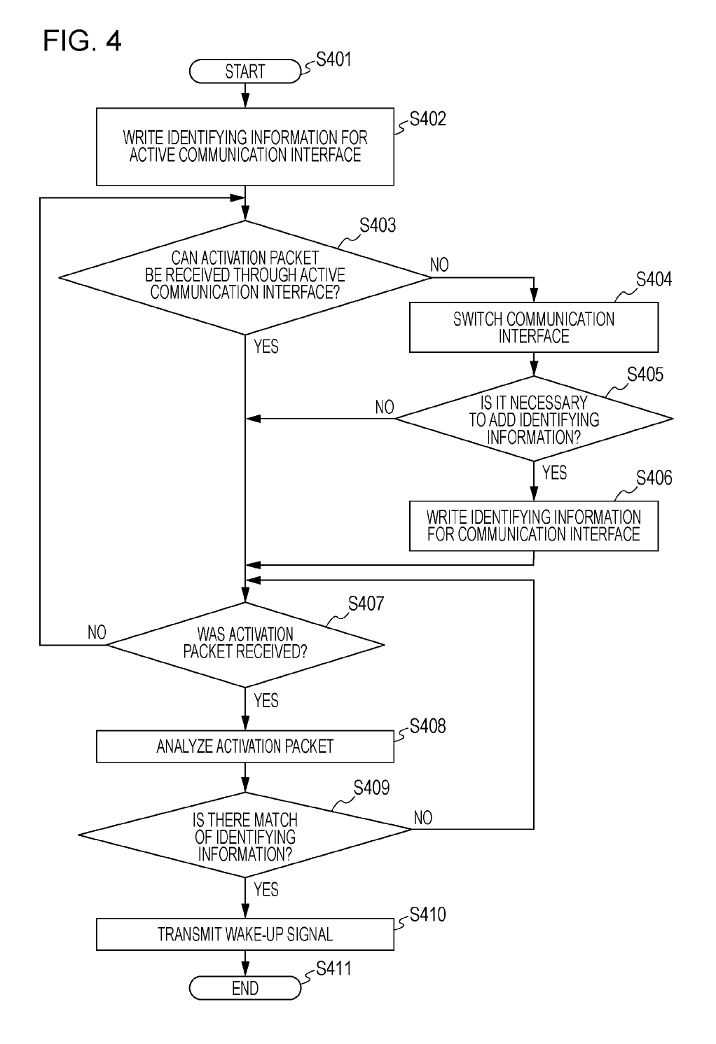

FIG. 4 is a flowchart that illustrates operation of the communication processing section 103 when the main processing section 102 shifts to a power-saving state.

When the main processing section 102 shifts to a power-saving state, the flow illustrated in FIG. 4 starts (S401). First, the interface control section 212 writes and stores, in the identifying information storage section 214, the identifying information for a communication interface being active, that is, a communication interface being in a state waiting for an activation packet (S402). Then the interface control section 212 determines whether an activation packet can be received through the communication interface being active on the basis of a communication status of each communication interface provided by the interface monitoring section 213 (S403). When determining that an activation packet can be received therethrough, the flow proceeds to S407; when determining that an activation packet cannot be received therethrough, the flow proceeds to S404.

In S404, the interface control section 212 switches the communication interface waiting for an activation packet. The interface control section 212 selects a communication interface that can receive an activation packet on the basis of a communication status of each communication interface provided by the interface monitoring section 213.

Then, the interface control section 212 determines whether it is necessary to write the identifying information for the communication interface selected in S404 into the identifying information storage section 214 (S405). When the identifying information for the communication interface selected in S404 has already been stored in the identifying information storage section 214, the flow proceeds to S407; when it has not been stored, the flow proceeds to S406. In S406, the interface control section 212 writes and stores the identifying information for the communication interface selected in S404 in the identifying information storage section 214. In S407, the communication processing section 103 determines whether the activation packet from an external communication device has been received by the transmission and reception processing section 211. When the activation packet has been received, the flow proceeds to S408; when the activation packet has not been received for a predetermined period, the flow proceeds to S403.

When the activation packet from the external communication device has been received (YES in S407), the packet analyzing section 210 analyzes the activation packet (S408) and notifies the comparing section 208 of the identifying information contained in the activation packet.

The comparing section 208 compares the identifying information provided by the packet analyzing section 210 and the identifying information stored in the identifying information storage section 214 and determines whether there is a match of the identifying information (S409).

As a result of the comparison, when there is a match of the identifying information, the flow proceeds to S410, where the comparing section 208 transmits a wake-up signal to the power control section 203 of the main processing section 102. When receiving the wake-up signal, the power control section 203 starts supplying power to the main processing section 102, and the main processing section 102 shifts from a power-saving state to a normal operation state. When in S409 it is determined that there is no match of the identifying information, the flow returns to S407, and a state waiting for reception of an activation packet is entered again. When the processing of S410 is completed, the flow illustrated in FIG. 4 ends (S411).

In such a way, according to this flow, also when there is a match between identifying information contained in an activation packet received through any one of the communication interfaces and identifying information for another communication interface, a power-saving state of the main processing section can be cancelled. When communication through a communication interface being active (in a state waiting for an activation packet) is disabled, the active communication interface is automatically switched to another communication interface. Thus the possibility of receiving an activation packet transmitted in a broadcast fashion can be increased.

For the flow illustrated in FIG. 4, when a communication interface to be active is selected, the identifying information for that communication interface is stored in the identifying information storage section 214 (S402, S406); however, it may be stored in advance.

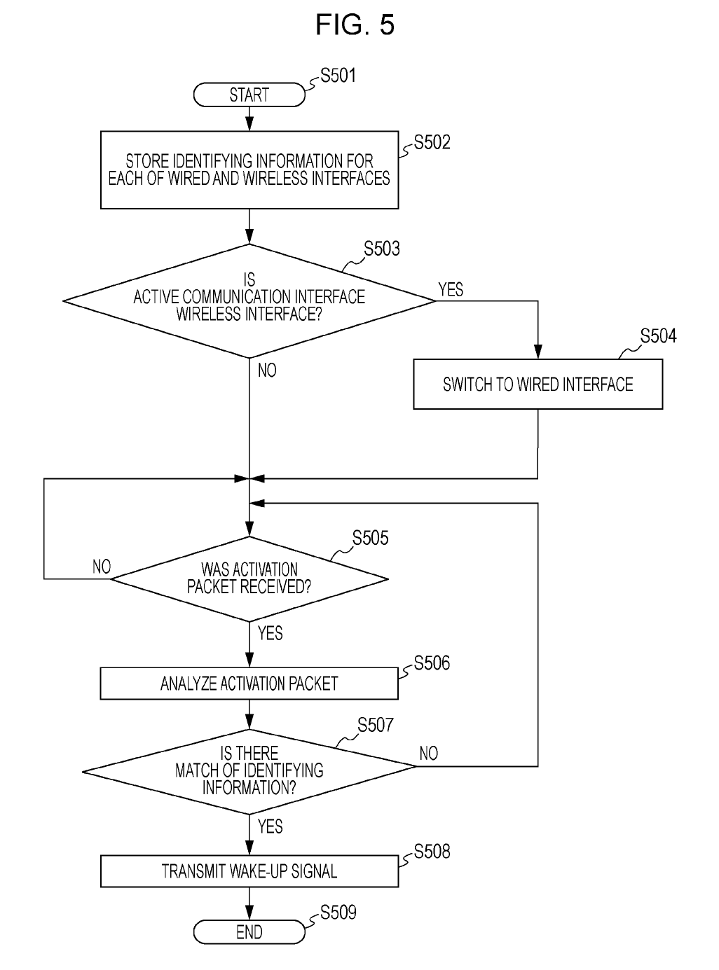

FIG. 5 illustrates a modification example of a flowchart of operation conducted by the communication processing section 103. As described above, the information processing apparatus 101 cannot cause the wired interface and the wireless interface to concurrently operate. Accordingly, even when the information processing apparatus 101 is connected to the wired communication device 106 through the connection cable 105, wired communication cannot be conducted during wireless connection with the wireless communication device 109.

When the main processing section 102 shifts to a power-saving state, the flow illustrated in FIG. 5 starts (S501). The interface control section 212 causes the identifying information storage section 214 to store the identifying information for each of the wired interface 215 and the wireless interface 216 therein (S502). Then the interface control section 212 determines whether the communication interface being active is the wireless interface 216 (S503). When the wired interface 215 is in active use, the flow proceeds to S505. When the wireless interface 216 is in active use, the interface control section 212 switches the active communication interface so as to cause the wired interface 215 to become active (S504). Then reception of an activation packet through the wired interface 215 is awaited (S505).

When an activation packet is received from an external communication device through the wired interface 215 (YES in S505), the packet analyzing section 210 analyzes the activation packet (S506) and notifies the comparing section 208 of the identifying information for the communication interface contained in the activation packet. The comparing section 208 compares the identifying information provided by the packet analyzing section 210 and the identifying information stored in the identifying information storage section 214 and determines whether there is a match of the identifying information (S507). As a result of the comparison, when there is a match of the identifying information, the flow proceeds to S508, where the comparing section 208 transmits a wake-up signal to the power control section 203 of the main processing section 102. When receiving the wake-up signal, the power control section 203 starts supplying power to the main processing section 102, and the main processing section 102 shifts from a power-saving state to a normal operation state. When in S507 it is determined that there is no match of the identifying information, the flow returns to S505, and a state waiting for reception of an activation packet is entered again. When the processing of S508 is completed, the flow illustrated in FIG. 5 ends (S509).

The power consumption of wireless communication is larger than that of wired communication, and it is useful that power consumption be reduced as much as possible. According to this flow, if the active interface when the main processing section shifts to a power-saving state is the wireless interface, the active interface is switched to the wired interface, so power consumption can be reduced. In addition, the identifying information for each of the wired and wireless interfaces is stored in the identifying information storage section 214 in advance. Therefore, even when an activation packet containing the identifying information for the wireless interface is received through the wired interface, the state can be returned from a power-saving state.

For the above embodiment, an information processing apparatus configured not to concurrently use a plurality of communication interfaces is described as an example. However, the present invention is also applicable to a case where they can be concurrently used. In this case, processing of switching a communication interface described in S404 in FIG. 4 and S504 in FIG. 5 can be omitted.

For the above embodiment, an information processing apparatus that includes both a wired interface and a wireless interface is described as an example. However, the present invention is also applicable to a case where all communication interfaces are wired interfaces or wireless interfaces. Any number of communication interfaces is used as long as the number is more than one.

Some information processing apparatuses can switch between two operation states, i.e., a processing state and a standby state, as a normal operation state. The standby state is a state where part of power supply to the main processing section is stopped and an instruction for data processing from another apparatus is awaited, and this state shifts to a processing state immediately after the instruction for data processing is received. The processing state is a state where data processing, such as printing, is being executed. For the above embodiment, reception of an activation packet causes a shift from a power-saving state to a normal operation state. However, reception of an activation packet may also cause a shift from a power-saving state to a standby state or a shift from a power-saving state directly to a processing state.

As described above, when an information processing apparatus including a plurality of communication interfaces receives an activation packet through any of the communication interfaces, the information processing apparatus can shift from a power-saving state to another operation state.

In the foregoing description, an IEEE 802.11 compliant wireless LAN is described as an example. However, the present invention may also be carried out in other wireless media, such as a wireless universal serial bus (USB), Bluetooth (trademark), and ultra-wideband (UWB).

The present invention may also be executed by supplying a storage medium in which program code of software for achieving the above functions is stored to a system or an apparatus, reading the program code stored in the storage medium by a computer (CPU or microprocessor unit (MPU)) of the system or the apparatus, and executing the program code.

According to the present invention, when an information processing apparatus including a plurality of communication interfaces receives an activation packet through any of the communication interfaces, it can shift from a power-saving state to another operation state.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of International Application No. PCT/JP2009/068031, filed Oct. 19, 2009, which is hereby incorporated by reference herein in its entirety.

What is claimed is:

1. An apparatus comprising:
a plurality of communication interfaces;
a main section configured to perform control over a predetermined application;
a communication section configured to perform control over communication via the plurality of communication interfaces; and
a power control section configured to perform control over power supply to the main section,
wherein the communication section is configured to, when receiving an activation packet for causing the main section to shift from a power-saving state to another operation state via any one of the plurality of communication interfaces, if the activation packet contains identifying information for another communication interface, provide the power control section with an instruction to shift the main section from a power-saving state to another operation state.

2. The apparatus according to claim 1, further comprising an interface control section configured to prohibit the plurality of communication interfaces from being concurrently used.

3. The apparatus according to claim 2, wherein the interface control section is configured to, depending on a status of communication via a communication interface in active use, switch to waiting for reception of the activation packet using another communication interface.

4. The apparatus according to claim 2, wherein at least one of the plurality of communication interfaces is a wireless interface,
the interface control section is configured to, when the main section shifts to the power-saving state after data communication with an external device via the wireless interface is conducted, switch to waiting for reception of the activation packet using another communication interface.

5. The apparatus according to claim 1, wherein the communication section is configured to, when the identifying information for the communication interface through which the activation packet was received is contained in the activation packet, provide the power control section with the instruction to shift the main section from the power-saving state to the other operation state.

6. The apparatus according to claim 1, wherein the activation packet is a packet transmitted in a broadcast fashion, and the identifying information for the communication interface is stored in a data section of the activation packet.

7. An apparatus including a plurality of communication interfaces,
the apparatus comprising:
a receiving unit configured to receive an activation packet for causing the apparatus to shift from a power-saving state to another operation state via any one of the plurality of communication interfaces;
a determining unit configured to determine whether the received activation packet contains identifying information for another communication interface; and
a control unit configured to control the apparatus to shift from the power-saving state to the other operation state based on a determination made by the determining unit.

8. A method for an apparatus including a plurality of communication interfaces,
the method comprising:
receiving an activation packet for causing the apparatus to shift from a power-saving state to another operation state;
determining whether the received activation packet contains identifying information for another communication interface; and
controlling the apparatus to shift from the power-saving state to the other operation state based on a determination made in the determining.

9. A non-transitory computer-readable medium storing a computer program for causing a computer to operate as the apparatus according to claim 1.

10. The non-transitory computer-readable medium according to claim 9, wherein the apparatus further comprises an interface control section configured to prohibit the plurality of communication interfaces from being concurrently used.

11. The non-transitory computer-readable medium according to claim 10, wherein the interface control section is configured to, depending on a status of communication via a communication interface in active use, switch to waiting for reception of the activation packet using another communication interface.

12. The non-transitory computer-readable medium according to claim 10, wherein at least one of the plurality of communication interfaces is a wireless interface,
the interface control section is configured to, when the main section shifts to the power-saving state after data communication with an external device via the wireless interface is conducted, switch to waiting for reception of the activation packet using another communication interface.

13. The non-transitory computer-readable medium according to claim 9, wherein the communication section is configured to, when the identifying information for the communication interface through which the activation packet was received is contained in the activation packet, provide the power control section with the instruction to shift the main section from the power-saving state to the other operation state.

14. The non-transitory computer-readable medium according to claim 9, wherein the activation packet is a packet transmitted in a broadcast fashion, and the identifying information for the communication interface is stored in a data section of the activation packet.

15. A non-transitory computer-readable medium storing a computer program for causing a computer to operate as the apparatus according to claim 7.

16. A non-transitory computer-readable medium storing a computer program for causing a computer to execute the control method according to claim 8.
